(19) United States
(12) Patent Application Publication
(10) Pub. No.: US 2022/0403688 A1
(43) Pub. Date: Dec. 22, 2022

(54) DOOR ROD ASSEMBLY

(71) Applicant: Ron Zeitler, Saginaw, MI (US)

(72) Inventor: Ron Zeitler, Saginaw, MI (US)

(21) Appl. No.: 17/806,510

(22) Filed: Jun. 13, 2022

Related U.S. Application Data
(63) Continuation-in-part of application No. 16/101,929, filed on Aug. 13, 2018, now abandoned.

(51) Int. Cl. E05C 9/22; E05C 9/02

(52) U.S. Cl. CPC E05C 9/22; E05C 9/02; E05Y 2900/21

(57) ABSTRACT

A door rod assembly for multi-point latch uses. The desire in the use of this door rod assembly is to essentially air seal a cabinet or closing from exposure to the air. Such air can include dust, dirt, noxious chemical fumes and the like. The devices seal cabinets, rooms, or the like from such contaminants. Assembly of the rod assembly is facilitated by the novel rod guide utilized in the assembly.

### CROSS-REFERENCE TO RELATED APPLICATIONS

This application is a continuation-in-part of U.S. utility patent application Ser. No. 16/101,929 that was filed on Aug. 13, 2018 from which priority is claimed.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This specification deals with a door rod assembly for multi-point latch uses. The desire in the use of this door rod assembly is to essentially air seal a cabinet or closing from exposure to the air. Such air can include dust, dirt, noxious chemical fumes and the like. The devices of this invention seal cabinets, rooms, or the like from such contaminants.

Door closing mechanisms have been developed for a variety of purposes. One such development can be found in U.S. Pat. No. 5,061,011 that issued to Meriwether on Oct. 29, 1991, in which there is disclosed a door closure arrangement for paint cabinets or enclosures containing combustible materials. A spring biased, lever actuated mechanism automatically latches or locks the doors when they are rotated into the closed position.

U.S. Pat. No. 5,114,192 that issued May 19, 1992, to Toledo, et al deals with a latch assembly for use with a panic exit device. The latch member pivots downwardly upon opening pressure on the door and actuation of the panic exit device, to release the latch member from the receiving lug of the system.

There is disclosed in U.S. Pat. No. 5,161,837 that issued Nov. 10, 1992, to O'Brien II, a rod casing for activating vertically arranged latch bolts.

A security door lock with remote control is disclosed in U.S. Pat. No. 6,351,977 that issued on Mar. 5, 2002, to Pedroso, et al. The device is an electrically operated, strong, security system comprising a lock with remote control installed in a wall adjacent to a door frame or under a door. The device is capable of securing the door at the top and the bottom.

Hunt, et al, in U.S. Pat. No. 5,816,017, that issued Oct. 6, 1998, deals with a fire-retardant door having a vertical latch stile extending the length of the stile for receiving the elements of a concealed vertical rod exit device along with an expanding, fire resistant material for sealing the opening when subjected to heat.

Sullivan, in U.S. Pat. No. 1,922,062 that was filed Aug. 15, 1931, deals with a construction to limit the amount of projection of the lock mechanism from the inside of a door in which a tumbler plate cooperates with a locking cam.

U.S. patent publication 2010/0266332 (Ramsauer) that was published on Oct. 21, 2010, deals with an adapter for coupling a rod, such as a locking rod of a rod type closure to a lever, such as an actuating lever of a rod-type closure.

Nepsha, et al, in U.S. Patent Publication 2016/0244993, that was published on Aug. 25, 2016, deals with rod guide for mounting a latch rod to an enclosure. A base member includes a base member support surface. The base member supports the guide member with the guide opening at different distances from the surface of the enclosure when the guide member support surface is seated on the base member support surface with the guide member disposed at different respective rotational orientations relative to the base member.

Dirak, Inc., discloses a flatrod having guides. Dirak, Inc., “3-161.01SL flat Rod FS”, Oct. 1, 2012, Black Diamond Engineered products,Http://www.bdproduct.ca/wp-content/Uploads/2013/06/Dirak-Multi-Point-Systems-55.pdf (year: 2012).

None of the prior art devices or systems deal with a ramp shoe configuration that provides easy assembly, glide action that makes the door close easily and provide maximum door pressure to maintain water and dust tight seals.

### BRIEF SUMMARY OF THE INVENTION

Thus, what is disclosed herein is a door rod assembly. The door rod assembly comprises in combination a latch base wherein the latch base comprises a flat metal elongated plate having two ends with edges. The elongated plate has a centered opening through it for insertion of a door opening handle. Each of the ends have second openings through them near an edge. There is a latch base having a locking bar integrally attached perpendicular to the latch base near a side edge.

Each second opening has a bolt through it, and each bolt rotatably secures a rod adapter to the latch base. Each rod adapter has an attachment end and a rod receptor end, there being an elongated rod inserted in each rod receptor end.

Each rod has a ramp shoe enclosing a rod end opposite the inserted rod end.

There are two rod guides. Each rod guide is mounted on a rod guide base, wherein each rod guide base is fixedly attachable to a fixed stud in a door. A portion of the rod guide is insertable in, and held by, the rod guide base, and each rod is slidable in a rod guide.

### BRIEF DESCRIPTION OF THE SEVERAL VIEWS OF THE DRAWING(S)

FIG. 1A is a schematic of the door rod assembly of this invention minus the lower rod and associated components.

FIG. 1B is an exploded view of the assembly of FIG. 1A.

FIG. 1C is a stud that is used in a door, the Figure showing the approximate location of the stud behind the rod guide base.

FIG. 2A is a full side view of a rod guide of this invention.

FIG. 2B is an isometric view of the device of FIG. 2A.

FIG. 3A is a full front view of a rod guide base.

FIG. 3B is an isometric view of the device of FIG. 3A.

FIG. 4 is a full side view of a ramp shoe.

### DETAILED DESCRIPTION OF THE INVENTION AND DRAWINGS

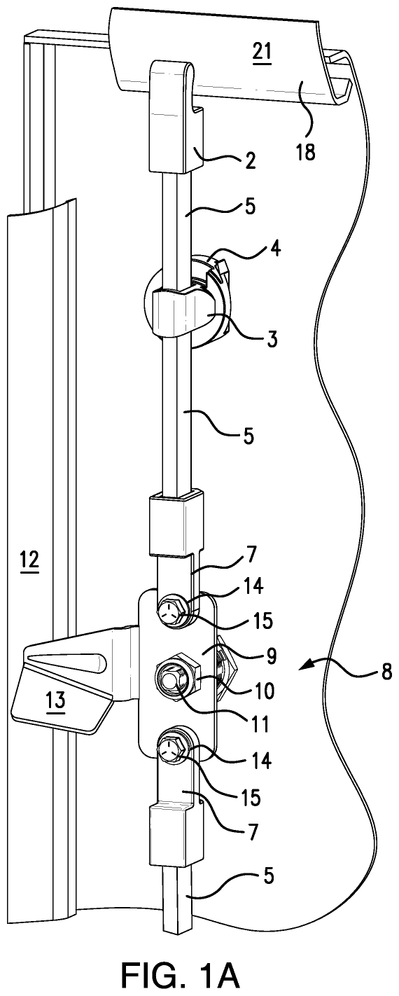

Turning now to FIG. 1A, there is shown a door rod assembly 1 of this invention minus the lower rod and associated components, which are a duplication of the assembly starting from the top of the latch base.

There is shown a latch base 8 which is comprised of a flat metal elongated plate 9 having a centered opening 10. This centered opening 10 is for the insertion of a door opening handle 11 (the tail end of which is shown), inserted into the opening 10 from the opposite side of the latch base 8. Use of this handle facilitates the locking, unlocking, and opening of the door (the door is not part of this invention).

Shown in dotted lines is a side door frame 12, against which the locking bar 13 of the latch base 8 snugly rests when the door is locked.

On either end of the latch base 8 are openings 14 near the edge. The openings have bolts 15 inserted therein to rotatably couple the rod adapter 7 to the latch base 8. The rod adapter 7 contains a rod 5, which extends some length to accommodate the distance between the latch base 8 in the locked position and the frame of the door, taking into consideration the length of the ramp shoe 2. The ramp shoe 2 is configured such that when the assembly 1 is open (the door is latched and locked), the ramp shoe 2 fits over the edge 18 of the top door frame 21 and secures the top of the door to the door frame.

In order to control and guide the rod 5, there is used a rod guide 3. The rod 5 slides through said rod guide 3. The rod guide 3 is attached to a rod guide base 4, which in turn is fastened to a door using a stud 16 (FIG. 1C). The rod guide 3 has an elongated tip 17 that rests against the side of the rod guide base 4 and prevents the rod 5 and associated assembly to move in a sidewise fashion.

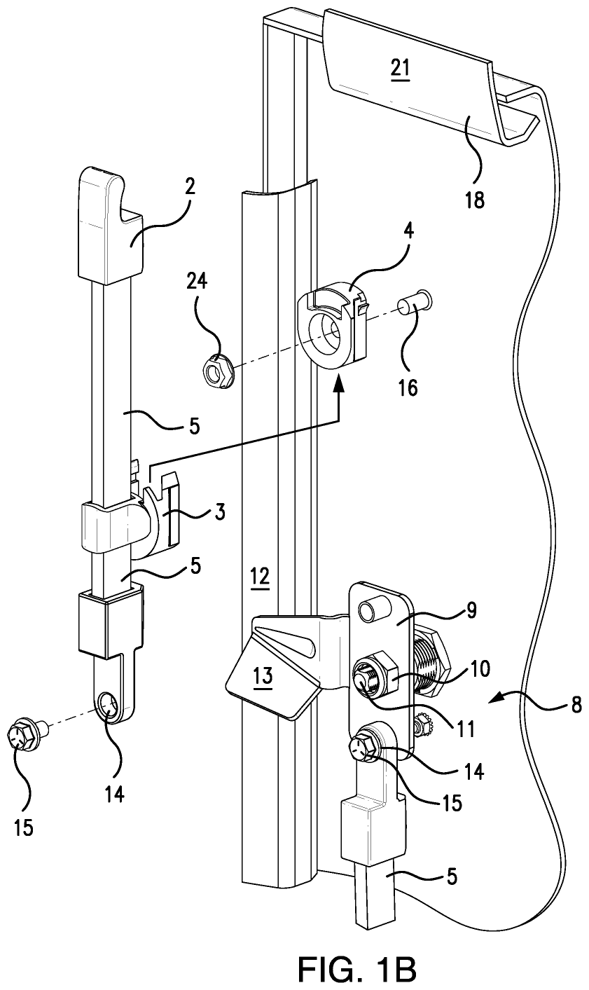

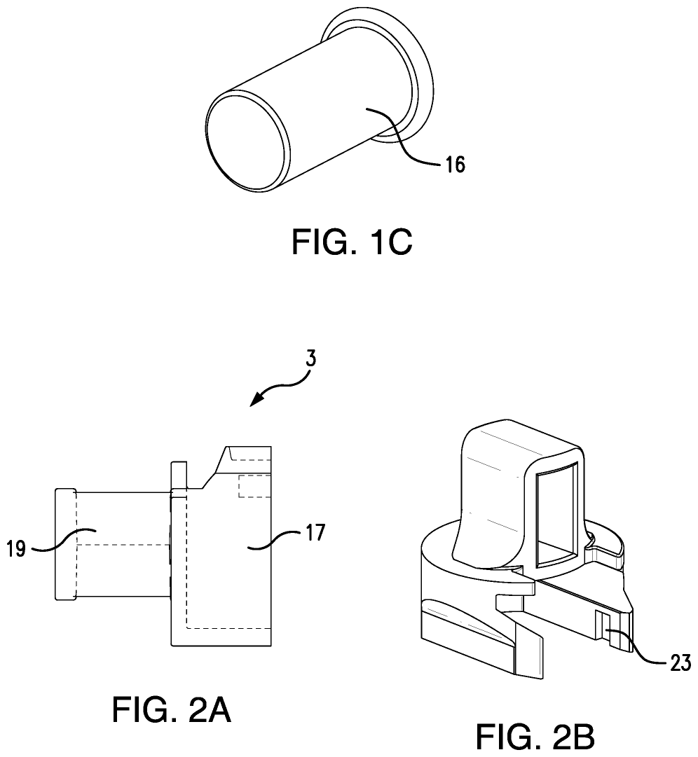

The rod guide base 4 is secured to the door with a nut 24. The rod guide 3 is slidable unto the rod guide base 4 and locks into place. The rod guide 3 is configured with integrated locking barbs 22 (see FIG. 3B) to receive rod guide 3 within retaining grove 23 (see FIG. 2B).

It is believed by the inventor herein, that the rod guides 3 are critical to the successful operation of the door rod assembly 1, as they prevent the sideways movement of the rod 5 and, further, they present a low friction movement of the rod through them to facilitate the smooth movement of the rod. In addition, the slide and lock feature allow the pre-assembled rod assembly to be placed on the door without having to incrementally construct the rod-assembly on the door. This is an efficient mode of manufacturing the door rod assembly. Nowhere in the prior art is there a disclosure of a door rod assembly attached to the door in which it is used in this manner.

It should be noted that a duplicate assembly is attached to the bottom of the latch base 8, and the rod adapter 7 and a portion of the rod 5 are shown in FIG. 1A.

FIG. 2A is a full side view of the rod guide 3 showing the tip 17 and the opening 19 through which the rod 5 slides (shown in phantom).

FIG. 3A is a full front view of the rod guide base 4 showing an opening 20 which receives the stud 16 (FIG. 1B) for mounting said rod guide base 4 to a door.

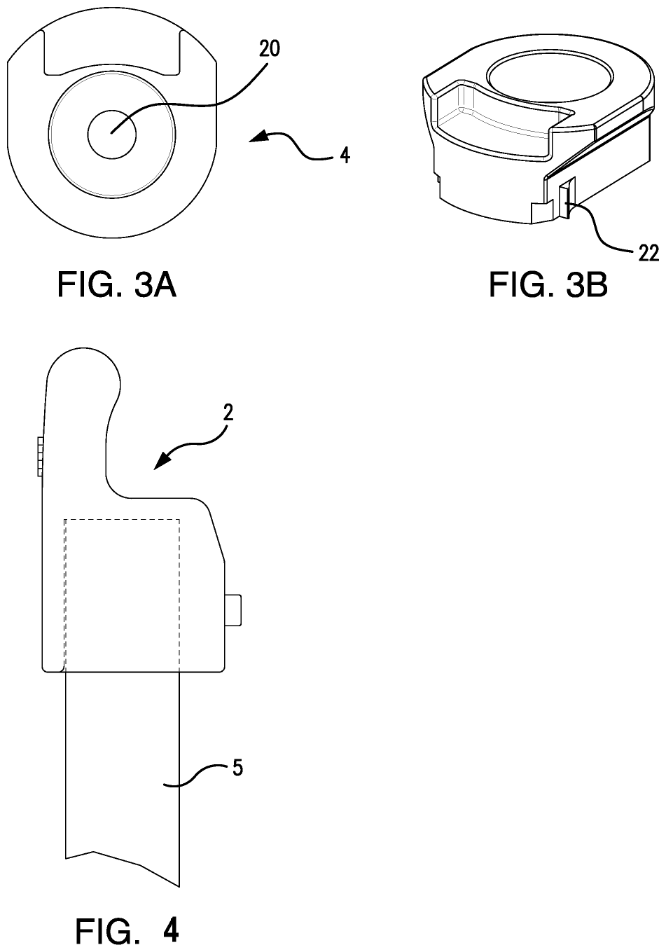

FIG. 4 is a full side view of a ramp shoe 2 showing a rod 5 inserted therein.

When assembled on a door, the door rod assembly 1 operates by turning the outside handle 11. This in turn moves the latch base 8 horizontal, which causes the latch 13 to be vertical (out of the path of the side door frame 12, and each rod adapter rotates such that the top rod assembly moves down and releases the ramp shoe 2 from the top door frame and the bottom rod assembly moves upward and causes the ramp shoe 2 on the bottom to release from the door frame 21.

Upon closing and locking the door, the reverse operation ensues. This creates a seal for the door against the door frame.

What is claimed is:

1. A door rod assembly, said door rod assembly comprising in combination:
A. a latch base, said latch base comprising a flat metal elongated plate having two ends with edges, said elongated plate having a centered opening therethrough for insertion of a door opening handle, each said end having second openings therethrough near each said edge, said latch base having a locking bar integrally attached perpendicular thereto at a side edge;
B. each said second opening having a bolt therethrough, each said bolt rotatably securing a rod adapter to said latch base, each said rod adapter having an attachment end and a rod receptor end, there being an elongated rod inserted in each said rod receptor end;
C. each said rod having a ramp shoe enclosing a rod end opposite said inserted rod end;
D. two rod guides, each said rod guide mounted on a rod guide base, each said rod guide base fixedly attachable to a fixed stud in a door, a portion of said rod guide insertable in, and held by, said rod guide base, each said rod slidable in said rod guide.
